(19) United States
(12) Patent Application Publication
(10) Pub. No.: US 2026/0235749 A1
(43) Pub. Date: Aug. 13, 2026

(54) OPERATION METHOD AND DOOR SENSING DEVICE THEREOF

(71) Applicant: TAIWAN FU HSING INDUSTRIAL CO., LTD., Kaohsiung City (TW)

(72) Inventors: I-Chang Shih, Kaohsiung City (TW); Pi-Shun Chang, Kaohsiung City (TW); Shih-Min Lu, Kaohsiung City (TW)

(73) Assignee: TAIWAN FU HSING INDUSTRIAL CO., LTD., Kaohsiung City (TW)

(21) Appl. No.: 19/330,860

(22) Filed: Sep. 17, 2025

(30) Foreign Application Priority Data
Feb. 12, 2025 (TW) 114105117

(51) Int. Cl. G01S 13/88; G01S 7/40; G01S 13/62

(52) U.S. Cl. CPC G01S 13/88; G01S 7/40; G01S 13/62

(57) ABSTRACT

An operation method based on a radar sensor is applied to a door sensing device having a signal emitter, a signal receiver and an operation processor. The operation method includes driving the signal emitter to emit a radar signal and then receiving the reflected radar signal by the signal receiver, analyzing the reflected radar signal to compare with a preset threshold, and deciding whether to adjust an execution parameter of the signal emitter and/or apply for a door determination parameter of the door sensing device.

### BACKGROUND OF THE INVENTION

### 1. Field of the Invention

The present invention relates to an operation method and a door sensing device, and more particularly, to an operation method and a related door sensing device based on the radar sensor with modulated frequency. 2. Description of the Prior Art

A conventional door sensing device usually uses the wireless signal sensing technology to determine whether the door is open or closed. For example, the infrared sensor sets the position and angle of the infrared beam to monitor the open mode or the closed mode of the door; the microwave sensor monitors the moving object close to the door and the stationary object stayed on the door's moving path; the radar sensor emits the laser wave of the specific frequency, which hits the target object and then returns to be received by the radar sensor, thereby converting the position and speed of the target object from the reflected laser wave. The conventional radar sensor has features of high frequency, high resolution and low sensitivity to environmental changes. However, the conventional radar sensor is operated at the fixed operating frequency, and is easily affected by environmental electromagnetic waves and electromagnetic waves generated by other devices, which results in frequent false alarms or omissions. Therefore, design of a door sensing device having preferred reliability and preferred anti-interference ability is an important issue in the related industry.

### SUMMARY OF THE INVENTION

The present invention provides an operation method and a related door sensing device based on the radar sensor with modulated frequency for solving above drawbacks.

According to the claimed invention, an operation method is based on a radar sensor and applied to a door sensing device having a signal emitter, a signal receiver and an operation processor. The operation method includes driving the signal emitter to emit a laser signal, and utilizing the signal receiver to receive the laser signal through reflection, analyzing the laser signal to compare with a preset threshold, and deciding whether to adjust an execution parameter of the signal emitter and/or a door determination parameter applied for the door sensing device in accordance with a comparison result of the laser signal and the preset threshold.

According to the claimed invention, a door sensing device includes a signal emitter, a signal receiver and an operation processor. The signal emitter is adapted to emit a laser signal. The signal receiver is adapted to receive the laser signal through reflection. The operation processor is electrically connected with the signal emitter and the signal receiver. The operation processor is adapted to analyze the laser signal to compare with a preset threshold, and decide whether to adjust an execution parameter of the signal emitter and/or a door determination parameter applied for the door sensing device in accordance with a comparison result of the laser signal and the preset threshold.

The operation method and the door sensing device of the present invention can use the millimeter wave radar with the frequency modulation function as the signal emitter; the operation processor can have an adaptive frequency adjustment algorithm or a spectrum analysis algorithm, and adopt the scheduled calibration process or the unscheduled calibration process to identify environmental interference, and then adjust the frequency band and/or the gain of the millimeter wave radar in accordance with the echo strength of the millimeter wave radar, or directly select the frequency band with the least interference to adjust the millimeter wave radar, or adjust the door determination parameter to improve the sensing accuracy of the door sensing device. Comparing to the prior art, the operation method and the door sensing device of the present invention can make good use of the high resolution feature of the millimeter wave radar to have the preferred sensing accuracy, and can be dynamically adjusted in accordance with application scenarios or weather conditions to provide reliable and accurate surveillance service.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a door sensing device according to an embodiment of the present invention.

FIG. 2 and FIG. 3 are application diagrams of the door sensing device according to different embodiments of the present invention.

FIG. 4 is a flow chart of the operation method in a correction phase according to the embodiment of the present invention.

FIG. 5 is a flow chart of the operation method in an application phase according to the embodiment of the present invention.

### DETAILED DESCRIPTION

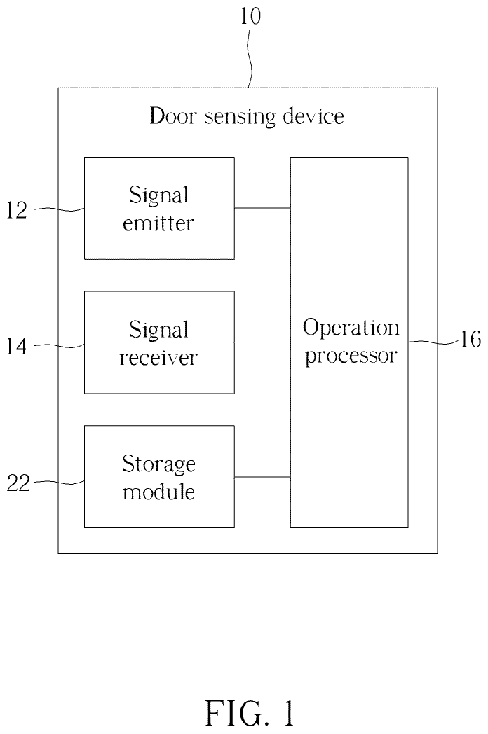

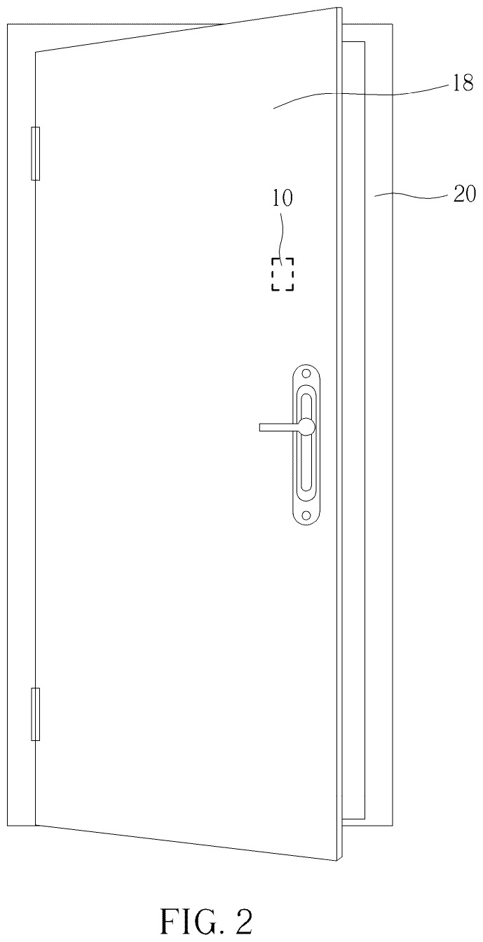

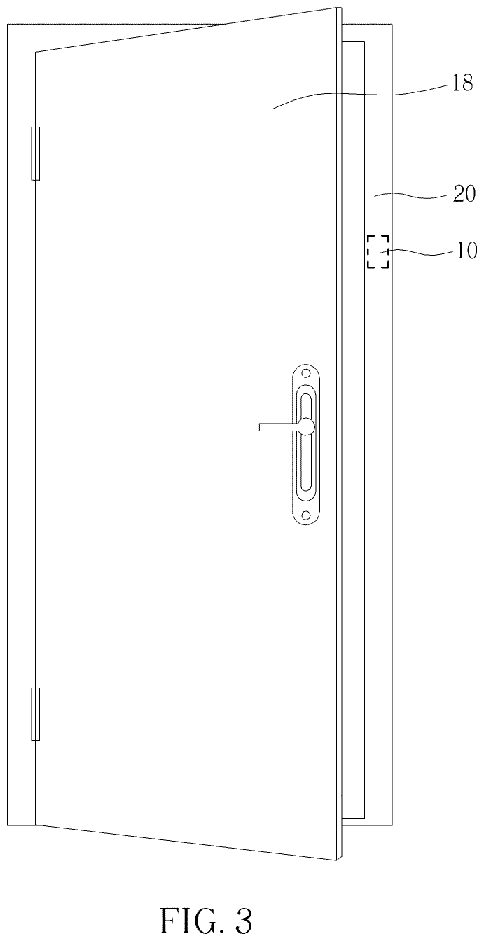

Please refer to FIG. 1 to FIG. 3. FIG. 1 is a functional block diagram of a door sensing device 10 according to an embodiment of the present invention. FIG. 2 and FIG. 3 are application diagrams of the door sensing device 10 according to different embodiments of the present invention. The door sensing device 10 can at least include a signal emitter 12, a signal receiver 14 and an operation processor 16 electrically connected with each other. The signal emitter 12 can emit a laser signal. The signal receiver 14 can receive the laser signal reflected from a target object (such as a door panel 18 or a door frame 20). The operation processor 16 can execute an operation method of the present invention to increase sensing reliability and anti-interference ability of the door sensing device 10

The door sensing device 10 can accurately determine position and a status of the door, and may be applied for other situations. For example, the door sensing device 10 can further sense a moving object or a stationary object, such as pedestrians, animals, vehicles; application of the door sensing device 10 can depend on an actual demand. The door sensing device 10 can further analyze a series of sensing data to estimate and compute a possible path of the object, for deciding whether the pedestrian moves towards or away from the door. In the present invention, the signal emitter 12 can be a millimeter wave radar with a frequency modulation function, and the door sensing device 10 can dynamically adjust the working frequency of the millimeter wave radar to avoid external interference and optimize its sensing performance, so as to obviously increase anti-interference ability of the millimeter wave radar and ensure that the door sensing device 10 can have stable sensing quality and preferred accuracy in the multiple interference environment.

As shown in FIG. 2, the door panel 18 can be rotated relative to the door frame 20 for switching between a closed state and an open status. The door sensing device 10 can be optionally disposed on the door panel 18, or may be disposed inside an electronic lock (which is not shown in the figures) on the door panel 18, for sensing relative position relationship of the door frame 20 and therefore providing a door position sensing function. Or, as shown in FIG. 3, the door sensing device 10 can be optionally disposed on the door frame 20 and used to sense the relative position relationship of the door panel 18 and provide the door position sensing function. Position of the door sensing device 10 is not limited to the foresaid embodiments, which depends on a design demand, and a detailed description is omitted herein for simplicity.

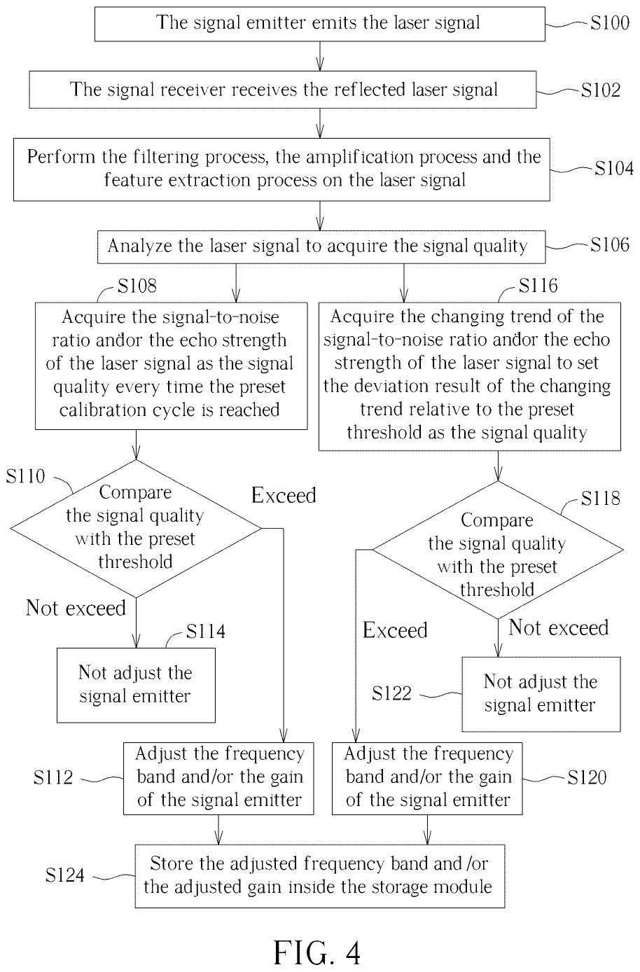

Please refer to FIG. 4. FIG. 4 is a flow chart of the operation method in a correction phase according to the embodiment of the present invention. The operation method illustrated in FIG. 4 can be suitable for the door sensing device 10 shown in FIG. 1 to FIG. 3. According to the operation method in the correction phase, step S100 and step S102 can be executed to drive the signal emitter 12 to emit the laser signal, and utilize the signal receiver 14 to receive the laser signal through reflection. Then, step S104 can be optionally executed to perform filtering process, amplification process and feature extraction process on the reflected laser signal. Generally, the present invention can perform the filtering process to remove noise and interference when the intensity of the collected laser signal is high, and then perform the amplification process to protect the amplifier and avoid nonlinear distortion; if the intensity of the collected laser signal is low, the amplification process may be performed first and then the filtering process can be performed to avoid noise amplification. The feature extraction process can extract the object sensing result such as reflection intensity, object distance and object speed that can describe the state of the target object(such as the door panel 18 or the door frame 20). Variation of the foresaid signal process can depend on signal features, and the detailed description is omitted herein for simplicity.

Then, step S106 can be executed to analyze the laser signal for acquiring the signal quality. If the door sensing device 10 adopts the scheduled calibration process, step S108 and step S110 can be executed to acquire a signal-to-noise ratio and/or echo strength of the laser signal as the signal quality every time a preset calibration cycle is reached, and compare the signal quality with a preset threshold. When the signal quality (which means the signal-to-noise ratio and/or the echo strength) is deviated from or exceeds a signal threshold of the preset threshold, sensing accuracy of the door sensing device 10 is decreased by the poor signal quality, and step S112 can be executed to adjust an execution parameter (such as a frequency band and/or a gain) of the signal emitter 12. When the signal quality is not deviated from or does not exceed the signal threshold of the preset threshold, the door sensing device 10 can have the preferred sensing accuracy due to the stable signal quality, and step S114 can be executed to not adjust the frequency band and/or the gain of the signal emitter 12.

If the door sensing device 10 adopts the unscheduled calibration process, step S116 and step S118 can be executed to continuously acquire a changing trend of the signal-to-noise ratio and/or the echo strength of the laser signal for setting a deviation result of the changing trend relative to the preset threshold as the signal quality, and compare the signal quality with the preset threshold. When the signal quality (which means the deviation result) is deviated from or exceeds a setting standard of the preset threshold, the sensing accuracy of the door sensing device 10 is affected by the poor signal quality, and an automatic correction function can be triggered to execute step S120 for adjusting the execution parameter (such as the frequency band and/or the gain) of the signal emitter 12. When the signal quality is not deviated from or does not exceed the setting standard of the preset threshold, the door sensing device 10 can have the preferred sensing accuracy due to the stable signal quality, and step S122 can be executed to not adjust the frequency band and/or the gain of the signal emitter 12.

In the scheduled calibration process of the operation method, the preset calibration cycle can be decided in accordance with an application demand of the door sensing device 10; for example, the door sensing device 10 can be set to perform calibration daily, weekly or monthly, and actual application is not limited to the foresaid embodiments, In the scheduled calibration process, the preset threshold can be preferably set as the signal threshold, which can be a threshold value converted from single error of the signal-to-noise ratio and/or the echo strength, or can be further defined in accordance with the design demand. In the unscheduled calibration process of the operation method, the deviation result can be a cumulative deviation value of the changing trend deviated from the signal threshold of the preset threshold; accordingly, the preset threshold can be preferably set as the setting standard converted from cumulative error of the signal-to-noise ratio and/or the echo strength. Final, after execution of step S112 and step S120 (for adjusting the execution parameter of the signal emitter 12), step S124 can be executed to store data of the adjusted frequency band and/or the adjusted gain inside the storage module 22 of the door sensing device 10, and stability and reliability of the related data can be verified in the subsequent door sensing process.

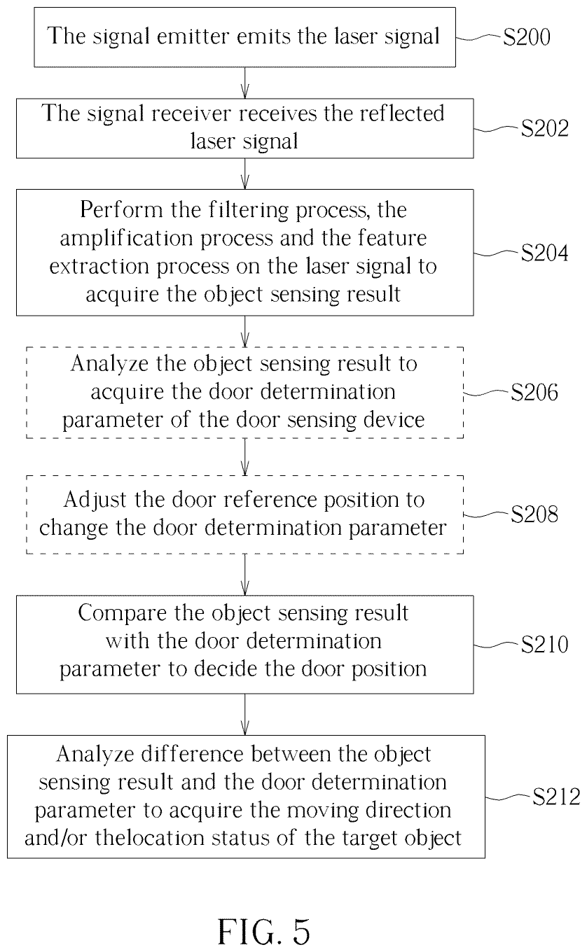

Please refer to FIG. 5. FIG. 5 is a flow chart of the operation method in an application phase according to the embodiment of the present invention. The operation method illustrated in FIG. 5 can be suitable for the door sensing device 10 shown in FIG. 1 to FIG. 3. According to the operation method in the application phase, step S200 and step S202 can be executed to drive the signal emitter 12 to emit the laser signal, and utilize the signal receiver 14 to receive the reflected laser signal. Then, step S204 can be optionally executed to perform the filtering process, the amplification process and the feature extraction process on the reflected laser signal for acquiring the object sensing result. The object sensing result can be applied to the door panel 18, the door frame 20 or the person, which depends on placement position of the door sensing device 10. The principles and functions of the signal process can be the same as or similar to the foresaid content, and the detailed description is omitted herein for simplicity.

Then, step S206 can be optionally executed to utilize the preset algorithm to analyze the object sensing result provided by the laser signal for establishing a door position model, so that the door reference position can be acquired based on the door position model to set as a door determination parameter of the door sensing device 10. Step S206 can be used to acquire a determination threshold (such as the door determination parameter) of the door position; the operation method of the present invention may acquire the door determination parameter via step S206 when installing the door sensing device 10, and this step is not executed in the following process; or, the operation method of the present invention may execute step S206 regularly or irregularly, so as to calibrate the door determination parameter, and further to avoid the door panel 18 and/or the door frame 20 from being displaced due to long-term use, thereby affecting the sensing accuracy of the door sensing device 10.

For increasing the sensing accuracy of the door sensing device 10, step S208 can be optionally executed to adjust the door reference position for changing the door determination parameter of the door sensing device 10 when the execution parameter of the signal emitter 12 is not adjusted. Then, step S210 can be executed to compare the object sensing result provided by the laser signal with the door determination parameter (which can correspond to the foresaid preset threshold) for deciding the door position; the object sensing result can be a value converted from the echo strength of the laser signal. Final, step S212 can be executed to analyze difference between the object sensing result and the door determination parameter by the preset algorithm, so as to acquire a moving direction and/or a location status of the target object (such as the door panel 18 or the door frame 20), and further to decide whether the door panel 18 is in the closed state (being close to the door frame 20) or in the open status (being away from the door frame 20).

In conclusion, the operation method and the door sensing device of the present invention can use the millimeter wave radar with the frequency modulation function as the signal emitter; the operation processor can have an adaptive frequency adjustment algorithm or a spectrum analysis algorithm, and adopt the scheduled calibration process or the unscheduled calibration process to identify environmental interference, and then adjust the frequency band and/or the gain of the millimeter wave radar in accordance with the echo strength of the millimeter wave radar, or directly select the frequency band with the least interference to adjust the millimeter wave radar, or adjust the door determination parameter to improve the sensing accuracy of the door sensing device. Comparing to the prior art, the operation method and the door sensing device of the present invention can make good use of the high resolution feature of the millimeter wave radar to have the preferred sensing accuracy, and can be dynamically adjusted in accordance with application scenarios or weather conditions to provide reliable and accurate surveillance service.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An operation method based on a radar sensor and applied to a door sensing device having a signal emitter, a signal receiver and an operation processor, the operation method comprising:
the operation processor driving the signal emitter to emit a laser signal, and utilizing the signal receiver to receive the laser signal through reflection;
the operation processor analyzing the laser signal to compare with a preset threshold; and
the operation processor deciding whether to adjust an execution parameter of the signal emitter and/or a door determination parameter applied for the door sensing device in accordance with a comparison result of the laser signal and the preset threshold.

2. The operation method of claim 1, further comprising:
the operation processor analyzing the laser signal to acquire a signal quality;
the operation processor deciding whether the signal quality conforms to the preset threshold; and
the operation processor automatically adjusting a frequency band and/or a gain of the execution parameter when the signal quality exceeds the preset threshold.

3. The operation method of claim 2, wherein the operation processor automatically adjusting the execution parameter of the signal emitter comprises:
the operation processor acquiring a signal-to-noise ratio and/or echo strength of the laser signal as the signal quality every time a preset calibration cycle is reached; and
the operation processor adjusting the frequency band and/or the gain of the signal emitter when the signal-to-noise ratio and/or the echo strength is deviated from a signal threshold of the preset threshold.

4. The operation method of claim 2, wherein the operation processor automatically adjusting the execution parameter of the signal emitter comprises:
the operation processor continuously acquiring a changing trend of a signal-to-noise ratio and/or echo strength of the laser signal;
the operation processor computing a deviation result of the changing trend relative to the preset threshold as the signal quality; and
the operation processor adjusting the frequency band and/or the gain of the signal emitter when the deviation result exceeds a setting standard of the preset threshold;
wherein the deviation result is a cumulative deviation value of the changing trend deviated from a signal threshold of the preset threshold.

5. The operation method of claim 2, further comprising:
the operation processor storing data of the adjusted frequency band and/or the adjusted gain inside a storage module of the door sensing device.

6. The operation method of claim 1, further comprising:
the operation processor performing filtering process and amplification process on the laser signal; and
the operation processor extracting a feature parameter from the processed laser signal to acquire an object sensing result.

7. The operation method of claim 6, further comprising:
the operation processor utilizing a preset algorithm to analyze the object sensing result for acquiring a door reference position as the door determination parameter.

8. The operation method of claim 7, wherein the operation processor adjusts the door reference position to increase accuracy of the door sensing device when the execution parameter of the signal emitter is not adjusted.

9. The operation method of claim 6, further comprising:
the operation processor utilizing a preset algorithm to analyze the object sensing result and the door determination parameter for acquiring a moving direction and/or a location status of a target object.

10. The operation method of claim 1, wherein the signal emitter is a millimeter wave radar with a frequency modulation function.

11. A door sensing device, comprising:
a signal emitter adapted to emit a laser signal;
a signal receiver adapted to receive the laser signal through reflection; and
an operation processor electrically connected with the signal emitter and the signal receiver, the operation processor being adapted to analyze the laser signal to compare with a preset threshold, and decide whether to adjust an execution parameter of the signal emitter and/or a door determination parameter applied for the door sensing device in accordance with a comparison result of the laser signal and the preset threshold.

12. The door sensing device of claim 11, wherein the operation processor is adapted to further analyze the laser signal to acquire a signal quality, decide whether the signal quality conforms to the preset threshold, and automatically adjust a frequency band and/or a gain of the execution parameter when the signal quality exceeds the preset threshold.

13. The door sensing device of claim 12, wherein the operation processor is adapted to further acquire a signal-to-noise ratio and/or echo strength of the laser signal as the signal quality every time a preset calibration cycle is reached, and adjust the frequency band and/or the gain of the signal emitter when the signal-to-noise ratio and/or the echo strength is deviated from a signal threshold of the preset threshold.

14. The door sensing device of claim 12, wherein the operation processor is adapted to further continuously acquire a changing trend of a signal-to-noise ratio and/or echo strength of the laser signal, compute a deviation result of the changing trend relative to the preset threshold as the signal quality, and adjust the frequency band and/or the gain of the signal emitter when the deviation result exceeds a setting standard of the preset threshold, the deviation result is a cumulative deviation value of the changing trend deviated from a signal threshold of the preset threshold.

15. The door sensing device of claim 12, wherein the operation processor is adapted to further store data of the adjusted frequency band and/or the adjusted gain inside a storage module of the door sensing device.

16. The door sensing device of claim 11, wherein the operation processor is adapted to further perform filtering process and amplification process on the laser signal, and extract a feature parameter from the processed laser signal to acquire an object sensing result.

17. The door sensing device of claim 16, wherein the operation processor is adapted to further utilize a preset algorithm to analyze the object sensing result for acquiring a door reference position as the door determination parameter.

18. The door sensing device of claim 17, wherein the operation processor is adapted to further adjust the door reference position for increasing accuracy of the door sensing device when the execution parameter of the signal emitter is not adjusted.

19. The door sensing device of claim 16, wherein the operation processor is adapted to further utilize a preset algorithm to analyze the object sensing result and the door determination parameter for acquiring a moving direction and/or a location status of a target object.

20. The door sensing device of claim 11, wherein the signal emitter is a millimeter wave radar with a frequency modulation function.
